(19) United States
(12) Patent Application Publication
(10) Pub. No.: US 2005/0038760 A1
(43) Pub. Date: Feb. 17, 2005

(54) Computer-implemented marketing integration method and implementation system

(76) Inventor: Timothy W. Rasmussen, Wildwood, MO (US)

Correspondence Address: Kenneth W. Float;The Law Offices of Kenneth W. Float, P.O. Box 80790, Rancho Santa Margarita, CA, 92688, US

(21) Appl. No.: 10/336,934

(22) Filed: Jan. 6, 2003

(51) Int. Cl. G06F 17/00

(52) U.S. Cl. 705/500

(57) ABSTRACT

Computer-implemented marketing integration methods and implementation systems are disclosed. The computer-implemented methods and implementation systems allow for rapid customization of various marketing tools, including brochures, letterhead, direct mail, door hangers, websites, presentations, pocket folders and print ads, and the like. The methods and implementation systems comprise selectable pre-developed design templates that are modified in accordance with customer preferences or selections by changing colors, type faces, photos and text to create customized end-products. Because of this ability to personalize and modify the designs, two designs using the same layout do not look alike. The method and implementation system also creates an integrated look and feel across marketing channels.

### BACKGROUND

The present invention relates generally to customized marketing tools, and more particularly, to a computer-implemented marketing integration method and implementation system.

There are two prior art techniques that address the problem of customizing marketing tools. These techniques are desktop publishing software and stock, pre-printed campaigns. Each of these techniques have their limitations.

Desktop publishing software, such as Microsoft Publisher®, for example, offers pre-existing designs that an end-user must modify themselves. The designs are very simple and are easily identified as Publisher designs. The designs look like do-it-yourself designs. Additionally, this prior art software technique requires some level of training and computer ability to successfully use it. Also, this software technique does not include a large library of professional photography.

Stock, pre-printed campaigns use pre-printed shells with blank areas for text to be over printed. This prior art technique only allows for a logo or text to vary. There is absolutely no flexibility in design or photography. Additionally, the only practitioners of this prior art technique are vertical market providers. For example, a company will have pre-printed brochure or direct mail shells for pest control companies. No stock campaigns have been found that integrate all the elements in the manner provided by the present invention.

It is therefore an objective of the present invention to provide for a computer-implemented marketing integration method and implementation system that easily customizes marketing tools in a manner not achievable by conventional techniques. It is another objective of the present invention to provide for a computer implemented marketing integration method and implementation system that provides small businesses with easily customizable marketing materials at lower cost than traditionally-produced custom marketing materials.

### SUMMARY OF THE INVENTION

To meet the above and other objectives, the present invention provides for computer-implemented marketing integration methods and implementation systems. The computer-implemented methods and implementation systems allow for rapid customization of various marketing tools, including brochures, letterhead, direct mail, door hangers, websites, presentations, pocket folders and print ads, and the like. The methods and implementation systems comprise selectable pre-developed design templates that are modified in accordance with customer preferences or selections by changing colors, type faces, photos and text to create customized end-products. Because of this ability to personalize and modify the designs, two designs using the same layout do not look alike. The method and implementation system also creates an integrated look and feel across marketing channels.

One exemplary embodiment of the method and implementation system comprises a computer system including software that are operated by a marketing professional who interfaces with a customer. A predetermined number of sets of customizable marketing design templates that have been generated by marketing professionals reside on the computer system operated by the marketing professional. Each template of each set is divided into a predetermined number of customizable sections, and each section is selectively customizable with one or more insertable photographic images, one or more insertable graphic images, and insertable textual information (copy). Each section is also customizable as to background color, text color, and text typeface.

The customer selects one of a plurality of preformatted design templates relating to the customer's business. The customer then selects a predefined style package along with colors that are to be used in the selected template. The customer then indicates if a logo or graphic image is to be added to the template and identifies the form of the logo that is to be submitted, indicating whether it is an electronic file, color print or original artwork. Alternatively, a logo may be created by the marketing professional. The color of the logo is selected, based upon the colors chosen for the selected style package. Copy (i.e., headlines, body text, etc.) is identified and submitted in a predetermined electronic format. Photographs that are to be inserted into the selected design template are submitted by the customer or are selected by the marketing professional. The customer then selects one or more individual marketing items or marketing packages that are to be created by the marketing professional using the copy, photographs and logo or graphic image. The marketing professional creates the desired marketing items or packages for the customer on the computer system.

The present invention thus provides for a plurality of preformatted design templates that each have a plurality of separate areas or sections into which text, graphic images and photographs are inserted to create a semi-custom design layout. In addition, different background color schemes, text colors, text styles may be selected by the customer. A plurality of professionally created royalty-free images are provided that may be selectively inserted into one or more of the separate areas of the preformatted design templates.

Another exemplary embodiment of the method and implementation system comprises a computer system and software that are operated by a marketing professional and a computer and software that are operated by a customer that communicated over a network, such as the Internet, for example. In this embodiment, on-line selections are made by the customer regarding the desired design template, style package, background and text colors, text typeface, and graphic images or photographs that are to be used in the design template. The customer submits textual copy, logos, graphic images, etc., to the marketing professional, preferably electronically. The marketing professional integrates the customer-selected and/or submitted colors, typeface, graphic images and/or photographs into the customer-selected design template, and style package to generate the desired marketing materials.

The method and implementation system are embodied in a CommuniKits™ line of marketing tools, which provides for small business marketing and advertising. The method and implementation system gives even the smallest of businesses professional marketing capabilities at a price point that bridges the chasm between do-it-yourself marketing software or office products and high-end, custom-developed marketing materials that that has traditionally been developed.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates a first exemplary embodiment of a computer-implemented marketing implementation system in accordance with the principles of the present invention;

FIG. 1a illustrates a second exemplary embodiment of a computer-implemented marketing implementation system in accordance with the principles of the present invention;

FIGS. 2-13 illustrate exemplary marketing design templates employed in the systems and methods of the present invention; and

FIG. 14 is a flow diagram that illustrates an exemplary computer-implemented marketing integration method in accordance with the principles of the present invention.

### DETAILED DESCRIPTION

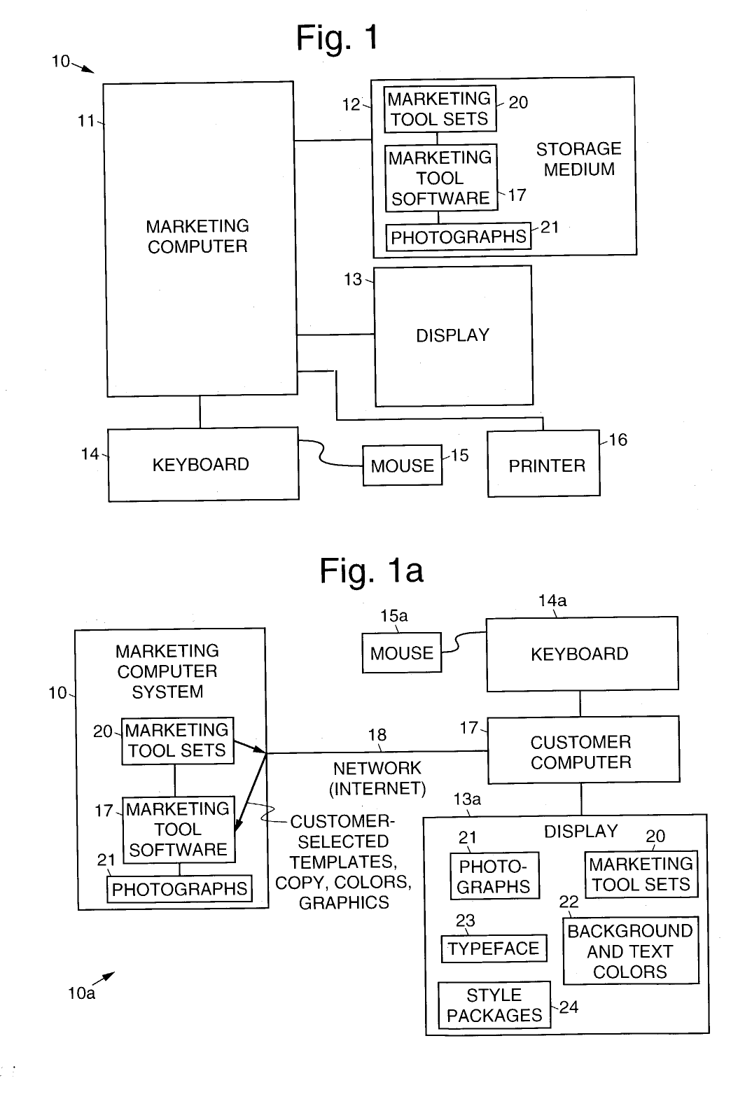

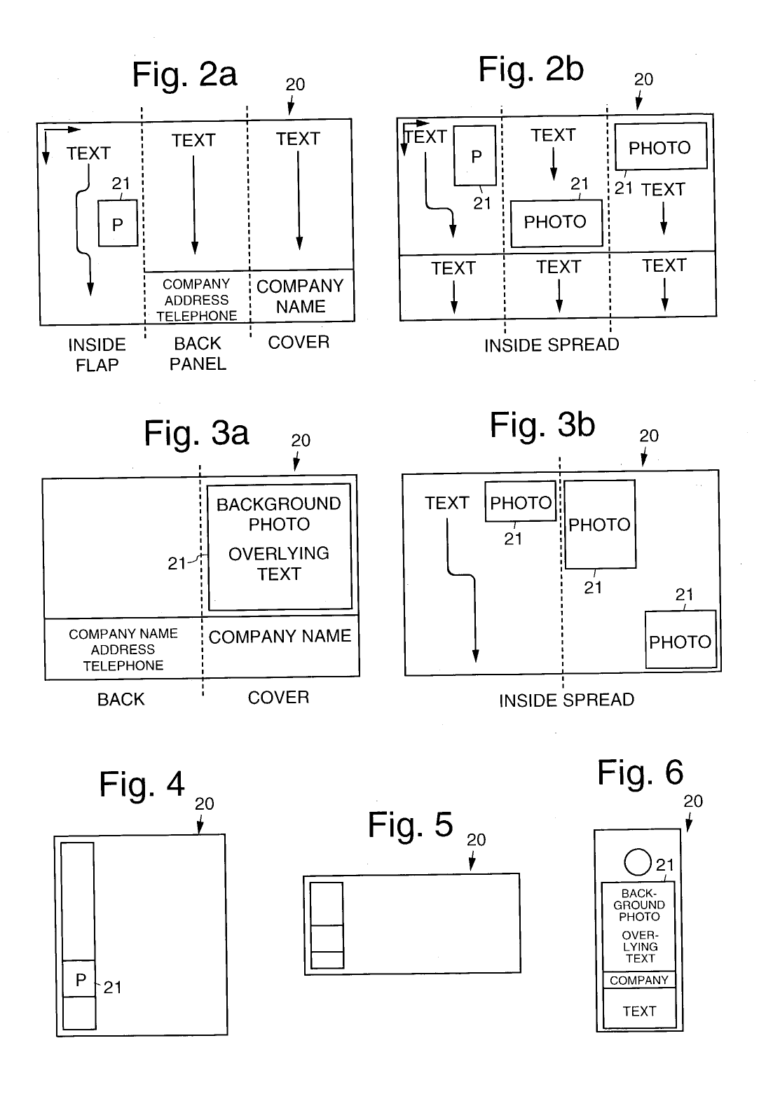

Referring to the drawing figures, FIG. 1 illustrates a first exemplary embodiment of a computer-implemented marketing implementation system 10 in accordance with the principles of the present invention. The first exemplary embodiment of the computer-implemented marketing implementation system 10 comprises a marketing computer 11 having a storage medium 12. The marketing computer 11 also comprises a display 13, a keyboard 14, and a mouse 15. The marketing computer 11 is coupled to a printer 16. The storage medium 12 contains marketing tool software 17 for customizing marketing tools for customers. The storage medium 12 also contains a plurality of professionally designed, pre-developed, customizable marketing tool sets 20 comprising different customizable design templates 20, and a plurality of professional digitized photographic images 21 (also identified as Photo or “P”) that may be selectively included in the customizable design templates 20 of the marketing tool sets 20. A marketing professional operates the marketing computer 11.

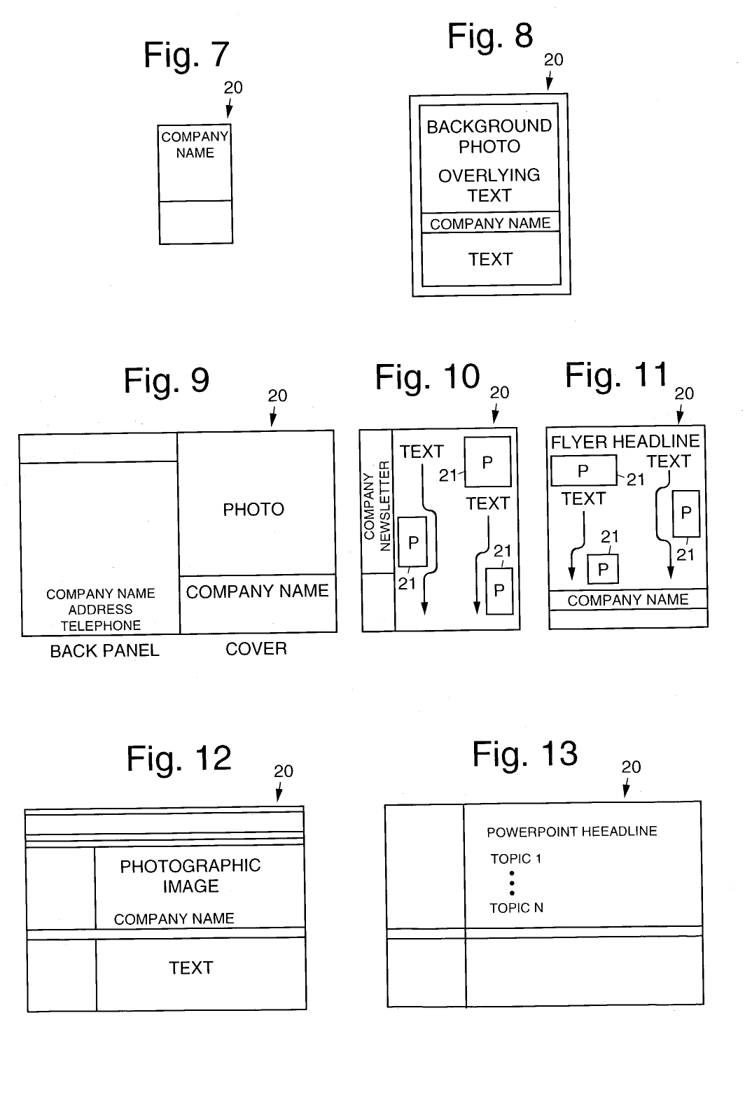

FIGS. 2-13 illustrate exemplary marketing design templates 20 employed in the present invention. FIG. 2a illustrates a first side of a foldable 8.5″ by 11″ brochure implemented using a first style package. FIG. 2b illustrates a second side of the foldable 8.5″ by 11″ brochure shown in FIG. 2a. The arrows on the brochure indicate that text and graphics may be presented in portrait and landscape orientations. The dashed lines on the brochure shown in FIGS. 2a and 2b indicate fold lines.

FIG. 3a illustrates one side (back and cover) of a foldable 11″ by 17″ brochure implemented using the first style package. FIG. 3b illustrates an opposite side (inside spread) of the foldable 11″ by 17″ brochure shown in FIG. 3a. The dashed lines on the brochure shown in FIGS. 3a and 3b indicate fold lines.

FIG. 4 illustrates an exemplary letterhead using a second style package. FIG. 5 illustrates an exemplary #10 envelope using the second style package. FIG. 6 illustrates an exemplary door hanger using the second style package. FIG. 7 illustrates an exemplary business card using the second style package. FIG. 8 illustrates an exemplary direct mail postcard using the second style package.

FIG. 9 illustrates an exemplary pocket folder using the third style package. FIG. 10 illustrates an exemplary newsletter using the third style package. FIG. 11 illustrates an exemplary flyer using the third style package. FIG. 12 illustrates an exemplary website design using the second style package. FIG. 13 illustrates an exemplary PowerPoint® template 20 using the third style package.

A customer may use a catalog containing illustrations of the various marketing tool sets 20 that correspond to different design packages to select the particular marketing tools that are desired. The customer and selectively chooses one or more items from a design package comprising the marketing tool sets 20. The customer also chooses a predefined style package, background colors, typeface, graphic images (icons), and copy that is to be used in the selected design package. An order form may be employed that is filled out by the customer and forwarded to the marketing professional, or the customer may contact the marketing professional telephonically to place an order. Customer-generated copy, logos, graphic images, and the like that are to be used are forwarded, preferably electronically, to the marketing professional for optional editing and inclusion into the selected design package.

For example, the customer selects one of a plurality of preformatted design templates 20 relating to the customer's business. The customer then selects a predefined style package along with colors that are to be used in the selected template 20. The customer then indicates if a logo or graphic image is to be added to the template 20 and identifies the form of the logo that is to be submitted, indicating whether it is an electronic file, color print or original artwork. Alternatively, a logo may be created by the marketing professional. The color of the logo is selected, based upon the colors chosen for the selected style package.

Copy (i.e., headlines, body text, etc.) is identified and submitted in a predetermined electronic format. Photographs that are to be inserted into the selected design template 20 are submitted by the customer or are selected by the marketing professional. The customer then selects one or more individual marketing items or marketing packages that are to be created by the marketing professional using the copy, photographs and logo or graphic image. The marketing professional creates the desired marketing items or packages for the customer on the computer system.

The selectable pre-developed design templates 20 are modified in accordance with customer preferences or selections by changing colors, typefaces, photographic images and text to create customized marketing tools. Because of this ability to personalize and modify the design templates 20, two designs using the same layout do not look alike. The system 10 also creates marketing tools that have an integrated look and feel across marketing channels (i.e., each of the selected items in a selected marketing package).

A reduced-to-practice embodiment of the system 10 allow customers to choose from one of 15 different design packages comprising the marketing tool sets 20. Design packages contained in the marketing tool sets 20 include both industry and design themes. The industry-specific design packages include general business, legal, medical and healthcare, technology, construction, home services, manufacturing, food/restaurant, sports and recreation and real estate. The design theme packages include classic, outdoor, elegance, retro and children. Each design package comprises a complete range of marketing tools including: small-format brochures, large-format brochures, business cards, letterhead, envelopes, pocket folders, print ads, direct mail post cards, door hangers, flyers, newsletters, PowerPoint® presentation templates 20, and websites, such as those illustrated in FIGS. 2-13.

Customers can order desired items ala carte or in promotionally chosen packages. The present invention offers customization and flexibility through its various design packages, type and color combinations and photographic image selections.

For example, in a preferred embodiment, customers choose from among the 15 different design packages. Each design package offers 3 different color and type options and includes approximately 100 professional photographic images from which to choose.

In the preferred embodiment of present invention also provides customers with three options when it comes to copy. Customers can provide their own text, have a professional edit customer-provided verbiage or have the professional write original text based upon a copy outline they provide.

Referring now to FIG. 1a, it illustrates a second exemplary embodiment of a computer-implemented marketing implementation system 10a in accordance with the principles of the present invention.

The second exemplary embodiment of the computer-implemented marketing implementation system 10a comprises a marketing computer 11, software 20 and photographic images 21 discussed with regard to FIG. 1. The marketing computer 11 is implemented in the manner discussed above with regard to FIG. 1. A marketing professional operates the marketing computer 11.

The second exemplary computer-implemented marketing implementation system 10a also includes a customer computer 17 and software 17a that are operated by a customer that communicated over a network 18, such as the Internet, for example. The customer computer 17 and software 17a cooperate to display the contents of the brochure, including the marketing tool sets 20 comprising the design templates 20, style packages 24, available background and text colors 22, available text typefaces 23, and available photographic images 21 that may be used.

The software 17a running on the customer computer 17 displays the marketing tool sets 20 (design templates 20), style packages 24, available background and text colors 22, available text typefaces 23, and available photographic images 21.

In the second embodiment, on-line selections are made by the customer regarding the desired design template 20, style package, background and text colors, text typeface, and graphic images or photographic images that are to be used in the design template 20. The customer submits textual copy, logos, graphic images, etc., to the marketing professional, preferably electronically, by way of the network 18. The marketing professional integrates the customer-selected and/or submitted colors 22, typeface 23, graphic and/or photographic images 21 into the customer-selected design template 20, and style package 24 to generate the desired marketing materials.

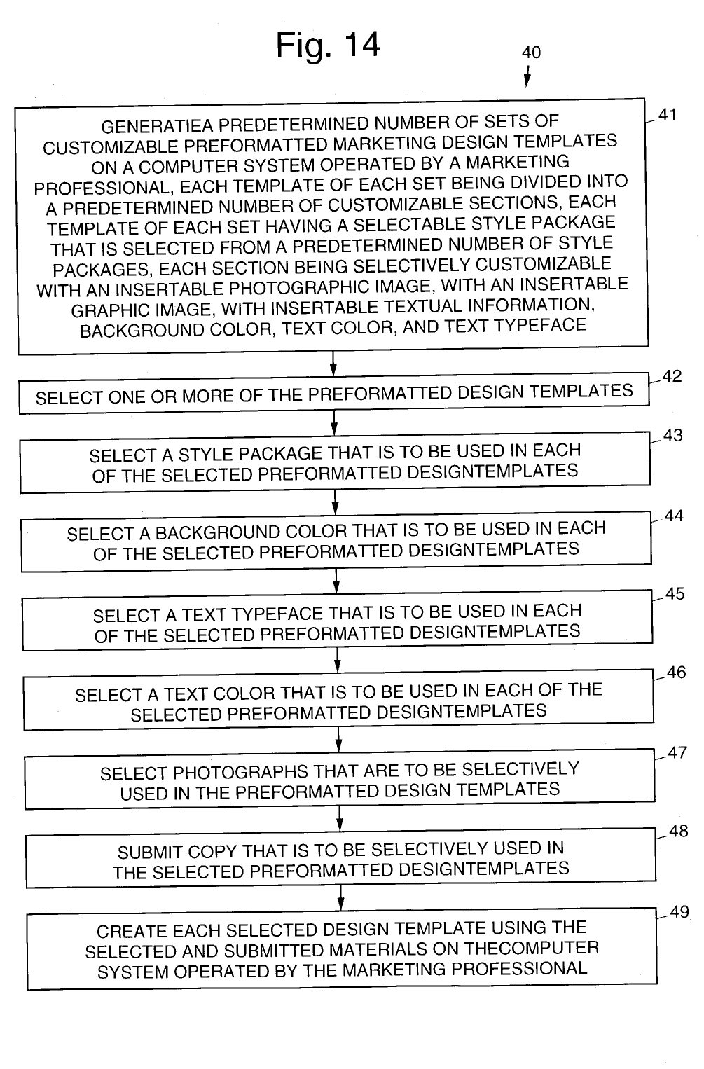

For the purposes of completeness, and referring to FIG. 14, it is a flow diagram that illustrates an exemplary computer-implemented marketing integration method 40 in accordance with the principles of the present invention. The exemplary method 40 produces customized marketing materials for a customer. The exemplary method 40 comprises the following steps.

A predetermined number of sets of customizable preformatted marketing design templates 20 are generated 41 on a computer system operated by a marketing professional, each template 20 of each set being divided into a predetermined number of customizable sections, each template 20 of each set having a selectable style package that is selected from a predetermined number of style packages, each section being selectively customizable with an insertable photographic image, each section being selectively customizable with an insertable graphic image, each section being selectively customizable with insertable textual information, each section being customizable as to background color, text color, and text typeface;

One or more of the preformatted design templates 20 is selected 42. A style package is selected 43 that is to be used in each of the selected preformatted design templates 20. A background color is selected 44 that is to be used in each of the selected preformatted design templates 20. A text typeface is selected 45 that is to be used in each of the selected preformatted design templates 20. A text color is selected 46 that is to be used in each of the selected preformatted design templates 20.

Photographs are selected 47 that are to be selectively used in the preformatted design templates 20. Copy is selected 48 that is to be selectively used in the selected preformatted design templates 20. Finally, each selected design template 20 is created 49 using the selected and submitted materials on the computer operated by the marketing professional.

The frustrations that small businesses have in developing their marketing materials, specifically relating to time, expertise, resources and affordability, are eliminated by the present invention. With the present invention, the burden is removed from the business owner, and a single marketing element or an entire marketing campaign may be constructed in relatively short order.

Not only is the finished product professional looking, it can be made that way very quickly. In contrast, the typical design process for custom work can take weeks in-and-of itself. Furthermore, the present invention is not only faster than custom processes, but is much more affordable. In fact, marketing tools created using the present invention can cost 60 to 75 percent less than custom work.

Small businesses often resort to developing their own marketing materials because they have not usually had access to affordable professional marketing services. The present invention may be used to help small businesses maximize the effectiveness of small business marketing. The basic tools offered by the present invention are a critical part of that effort. Small businesses have limited budgets, and the present invention was developed to give them unprecedented impact and value for those budgets.

While professional marketing firms have always been in a position to effectively serve small businesses, the custom work is generally too expensive for the very small client. The present invention allows marketing professionals to serve virtually any business. The present invention helps small business clients to continue growing small businesses.

Compared with customer-operated desktop publishing solutions, using the present invention, the marketing professional performs the work, not the customer, the marketing professional leverages professional, high-quality design rather than simple templates 20, the marketing professional uses professional software that requires extensive training, the marketing professional provide the customer with access to thousands of professional royalty-free images, the marketing professional can help the end-user write the copy that is to be used, the marketing professional can consult with the customer on how to apply these marketing tools, the marketing professional professionally prints the end product, the marketing professional has a greater array of items that can be created, and the marketing professional create “off-the-menu” solutions for the customer at a reduced cost compared with customized solutions.

Compared with stock, pre-printed marketing solutions, using the present invention, the marketing professional leverages professional, high-quality design rather than rigid templates, the marketing professional has access to thousands of professional royalty-free images, the marketing professional can help the end-user write the copy that is to be used, the marketing professional can consult with the end-user on how to apply these marketing tools, the marketing professional professionally prints the end product, the marketing professional can create two-color or full-color end products, the marketing professional can modify the design, the marketing professional can upgrade or change the paper stock on printed items, the marketing professional has a greater array of items that can be created, and the marketing professional can create “off-the-menu” solutions.

Thus computer-implemented marketing integration methods and implementation systems have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

1. A method of producing customized marketing materials for a customer, comprising the steps of:
generating a predetermined number of sets of customizable preformatted marketing design templates on a computer system operated by a marketing professional, each template of each set being divided into a predetermined number of customizable sections, each section being selectively customizable with an insertable image, with insertable text information, and text typeface;
selecting one or more of the preformatted design templates;
selecting a text typeface that is to be used in each of the selected preformatted design templates;
selecting one or more images for insertion in the selected preformatted design templates;
submitting text information for insertion in the selected preformatted design templates; and
creating each selected design template using the selected and submitted materials on the computer system operated by the marketing professional.

2. The method recited in claim 1 wherein each template of each set has a selectable style package that is selected from a predetermined number of style packages, and wherein the method further comprises the step of selecting a style package that is to be used in each of the selected preformatted design templates.

3. The method recited in claim 1 wherein each customizable section is selectively customizable with an insertable photographic image.

4. The method recited in claim 1 wherein each customizable section is selectively customizable with an insertable graphic image.

5. The method recited in claim 1 wherein each customizable section is selectively customizable with a background color, and wherein the method further comprises the step of selecting a background color that is to be used in each of the selected preformatted design templates.

6. The method recited in claim 1 wherein each customizable section is selectively customizable with a text color, and wherein the method further comprises the step of selecting a text color that is to be used in each of the selected preformatted design templates.

7. The method recited in claim 1 wherein a customer computer is used to select the one or more of the preformatted design templates, select the text typeface that is to be used in each of the selected preformatted design templates, select the one or more images for insertion in the selected preformatted design templates, and submit the text information for insertion in the selected preformatted design templates.

8. A computer-implemented marketing implementation system comprising:
a marketing computer comprising a storage medium, a display, a keyboard and a mouse;
a plurality of pre-developed, preformatted, customizable customer-selectable marketing tool sets comprising customizable sets of preformatted marketing design templates disposed on the marketing computer, each template of each set being divided into a predetermined number of customizable sections;
a plurality of customer-selectable digitized images disposed on the computer that may be selectively included in the templates disposed on the marketing computer;
marketing tool software disposed on the marketing computer that is operated by a marketing professional to customize marketing tools for customers; and
selection means for allowing a customer to select a preformatted design template, and text information, text typeface, and one or more digitized images for use in the selected preformatted design template.

9. The system recited in claim 8 wherein each template of each set is divided into a predetermined number of customizable sections.

10. The system recited in claim 8 wherein the plurality of customer-selectable professional digitized images comprise insertable digitized photographic images.

11. The system recited in claim 8 wherein the plurality of customer-selectable professional digitized images comprise insertable digitized graphic images.

12. The system recited in claim 8 wherein each template of each set has a selectable style package that is selected from a predetermined number of style packages, and wherein the selection means allows selection of a style package that is to be used in each of the selected preformatted design templates.

13. The system recited in claim 8 wherein each customizable section is selectively customizable with a text color, and wherein the selection means allows selection of the text color that is to be used in each of the selected preformatted design templates.

14. The system recited in claim 8 wherein each customizable section is selectively customizable with a background color, and wherein the selection means allows selection of the background color that is to be used in each of the selected preformatted design templates.

15. The system recited in claim 8 wherein the selection means comprises a customer computer coupled to the marketing computer by way of a network, which customer computer includes software for selecting the design template, style package, background and text colors, text typeface, and photographic images that are to be used in the selected design template.

16. The system recited in claim 15 wherein the customer computer comprises means for allowing the customer to submit text and graphic images to the marketing professional for inclusion in the selected design template.

17. The system recited in claim 8 wherein the selection means comprises an order form that is submitted to the marketing professional.

18. A computer-implemented marketing implementation system comprising:
a marketing computer comprising a storage medium, a display, a keyboard and a mouse;
a plurality of pre-developed, preformatted, customizable customer-selectable marketing tool sets comprising customizable sets of preformatted marketing design templates disposed on the marketing computer;
a plurality of customer-selectable professional digitized images disposed on the marketing computer that may be selectively included in the templates disposed on the marketing computer;
marketing tool software disposed on the computer that is operated by a marketing professional to customize marketing tools for customers; and
a customer computer coupled to the marketing computer by way of a network, which customer computer includes software for allowing a customer to select a preformatted design template, a text typeface and one or more images for use in the selected preformatted design template.

19. The system recited in claim 9 wherein the customer computer comprises means for allowing the customer to selectively submit text information and images to the marketing professional for inclusion in the selected preformatted design template.

20. The system recited in claim 9 wherein the customer computer comprises means for allowing the customer to selective text and background colors for use in the selected design template.
